(19) United States
(12) Patent Application Publication
(10) Pub. No.: US 2004/0259603 A1
(43) Pub. Date: Dec. 23, 2004

(54) Charging device for mobile terminals with integrated powerline modem

(76) Inventors: Kurt Aretz, Isselburg (DE); Wolfgang Groting, Oberhausen (DE); Ralf Kern, Bocholt (DE); Werner Troks, Ladbergen (DE)

Correspondence Address: STAAS & HALSEY LLP, SUITE 700, 1201 NEW YORK AVENUE, N.W., WASHINGTON, DC, 20005, US

(21) Appl. No.: 10/490,443

(22) PCT Filed: Sep. 20, 2002
(86) PCT No.: PCT/DE02/03533

(30) Foreign Application Priority Data
Sep. 24, 2001 (DE) 101 46 982.9

(51) Int. Cl. H04B 1/38

(52) U.S. Cl. 455/572

(57) ABSTRACT

A transmission facility (UE) for the transmission of information via power supply lines (EV) is integrated into the charging device (L) for mobile communication devices (M). Personal computers (PC) connected to these power supply lines (EV) can gain access to other networks such as local or broadband networks (LAN, WAN) via the inserted mobile communication device (M). The integration means that essential components of the charging device (L) have multiple applications and access overall is realized cost effectively.

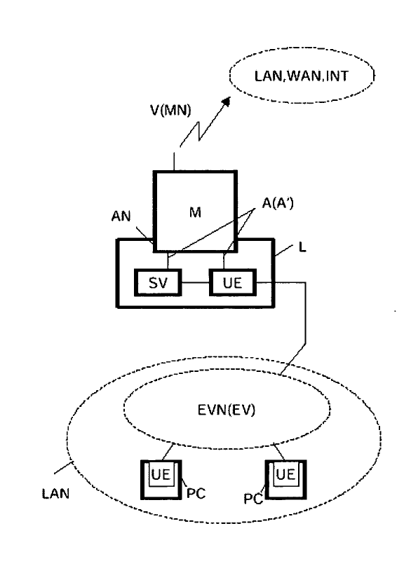

For the transmission of information, particularly data, local networks within buildings, also known professionally as LAN, are increasingly used. Power supply lines are also used for the transmission of information between computer terminals or other data terminals, with the data to be communicated being converted to signals suitable for transmission via power supply lines taking place in special transmission facilities, known professionally as powerline modems. To do this, the power supply lines leading to the terminals in the buildings can also be used for the transmission of information or data, i.e. special data transmission lines are not provided. To connect this local network to a higher-level broadband network, known professionally as a WAN, further cabling inside and outside the building is necessary. This means an additional, substantial economic cost.

Furthermore, mobile terminals, particularly mobile telephones, are suitable for the transmission of digitized voice information and data between the mobile terminals.

The object of the invention is to connect the local networks to broadband networks at low cost. This object is achieved by the features of claim 1.

The main aspect of the invention is the integration of a transmission facility for the transmission of information via power supply lines into a charging device for mobile communication terminals, with this being connected to the transmission facility when the mobile communication device is inserted. A main advantage of the invention is that personal computers (PC) connected to these power supply lines (EV) can gain access to other networks such as local or broadband networks (LAN, WAN) through the inserted mobile communication device (M) and, due to the integration, essential components of the charging device (L) are of multiple use and access can be realized overall at low cost.

Further advantageous embodiments are given in the further claims.

The invention is explained in more detail in the following with the aid of a drawing.

The drawing shows a charging device L with a power supply SV and a transmission facility UE. Furthermore, the charging device L has a recess AN for inserting a mobile communication device M, for example a mobile GSM terminal of a GSM mobile radio network. In the recess A, are terminals A, for example sockets, (not illustrated) in which mating terminals, for example pins, engage when the mobile communication device M is inserted, with an electrical connection thus being established both to the power supply SV and also to the transmission facility UE. The mobile communication device M is, for example, a conventional mobile telephone with the existing charging interface A being supplemented by a terminal A′ for a connection to a transmission facility UE, or one of the existing terminals A′ designed for other information communication is also used.

The transmission facility UE is designed in such a way that it is suitable for the transmission of information or data by power supply lines EV. In this case a single or multi-carrier method such as the OFDM (Orthogonal Frequency Digital Multiplex) transmission method or the DMT (Discrete Multitone) transmission method can be used, with the chosen transmission method depending on the number of other transmission facilities UE to be connected and the transmission speed to be achieved.

The data exchange between the mobile communication device M and the charging device L takes place via a digital asynchronous data flow, that is controlled with the aid of a two-wire data exchange protocol, for example in accordance with the standard communication protocol IEEE 802.3 or modified V.24. Particularly advantageous with the charging device L according to the invention is the use of existing circuit and program components of the mobile communication device. Furthermore, the data flow between the mobile communication device and the data flow that occurs during transmission via the power supply network EVN should be designed in such a way that conversion can be realized at low cost.

The transmission facility UE in the charging device L is connected through a power supply network EVN having at least one power supply line EV to further transmission facilities UE, that for example are arranged in or assigned to personal computers PC or other data terminals. With the aid of the transmission facilities UE, the personal computers PC or data terminals can exchange information or data with each other via the power supply network EVN, with the power supply network EVN preferably representing an in-house power supply network EVN and the transmission facilities UE being connected via coupling devices (not illustrated) to the power supply lines EV of the power supply network EVN. The personal computers PC connected to each other via the power supply network EVN represent, in the exemplary embodiment, a local LAN, shown in the drawing by an oval marked LAN, that for example has an intranet and additionally from which access to a further local network LAN or a higher-level broadband network WAN should be possible, at least temporarily.

Access to a further local network LAN or to a broadband network WAN or also to the Internet INT is achieved via the mobile communication device M. For this, a wireless connection V is established via a mobile radio network MN, indicated by an arrow marked V(MN). Information or data from one of the personal computers PC requiring access is then transmitted via the power supply network EVN, the transmission facilities UE in the charging device L, the mobile communication device M, and also via the mobile radio network MN, to other networks LAN, WAN, INT, and vice versa.

The charging device L according to the invention can also be used in other network configurations, such as for connecting individual personal computers PC to the Internet via the power supply network EVN. Simpler transmission methods for transmitting via power supply lines EV by connecting a few personal computers PC or other data terminals that require access to other networks LAN, WAN, INT are possible. The mobile communication devices M can be not only mobile terminals of a mobile radio network but also terminals of wireless networks, with which a connection to a local network LAN or to a broadband network WAN or to the Internet INT can be established, with, in addition to the wireless switched connections, permanent connections also being possible if required. The relevant signaling for this purpose is to be realized in the wireless or mobile communication devices or terminals.

1. Charging device for mobile communication devices, characterized in that
a transmission facility (UE) for the transmission of information signals via at least one power supply line (EV) is integrated and
that the communication device (M) inserted into the charging device is connected to the transmission facility (UE).

2-6. (cancelled)
